(19) United States
(12) Patent Application Publication
(10) Pub. No.: US 2021/0158700 A1
(43) Pub. Date: May 27, 2021

(54) Intelligent Driving Control Method and Device, and Storage Medium

(71) Applicant: Shanghai SenseTime Intelligent Technology Co., Ltd., Shanghai (CN)

(72) Inventor: Ningyuan Mao, Shanghai (CN)

(73) Assignee: Shanghai SenseTime Intelligent Technology Co., Ltd., Shanghai (CN)

(21) Appl. No.: 17/144,524

(22) Filed: Jan. 8, 2021

Related U.S. Application Data
(63) Continuation of application No. PCT/CN2019/097232, filed on Jul. 23, 2019.

(30) Foreign Application Priority Data
Jul. 28, 2018 (CN) 201810850399.0

(51) Int. Cl. G08G 1/0967; G08G 1/0962; G06K 9/00; G08B 21/18

(52) U.S. Cl. CPC G08G 1/096716; G08B 21/18; G06K 9/00791; G08G 1/09623

(57) ABSTRACT

Embodiments of the present disclosure provide an intelligent driving control method and device, and a storage medium, wherein the method comprises: detecting a traffic signal of a vehicle travelling environment to obtain a detection result of the traffic signal; acquiring a current travelling state of a vehicle and a vehicle default state corresponding to the detection result of the traffic signal; determining whether the current travelling state of the vehicle matches the vehicle default state; and in response to the current travelling state of the vehicle not matching the vehicle default state, outputting a driving alarm signal and/or a control signal for instructing the vehicle to switch from a current state to the vehicle default state.

### CROSS REFERENCE TO RELATED APPLICATIONS

The present disclosure is a continuation of and claims priority under 35 U.S.C. 120 to PCT Application. No. PCT/CN2019/097232, filed on Jul. 23, 2019 and entitled “SMART DRIVING CONTROL METHOD AND APPARATUS, VEHICLE, ELECTRONIC DEVICE, MEDIUM, AND PRODUCT”, which is based on and claims priority of Chinese Patent Application No. CN201810850399.0, filed to CNIPA on Jul. 28, 2018 and entitled “INTELLIGENT DRIVING CONTROL METHOD AND DEVICE, VEHICLE, ELECTRONIC APPARATUS, MEDIUM, AND PRODUCT”. All the above referenced priority documents are incorporated herein by reference in their entireties.

### TECHNICAL FIELD

The present disclosure relates to vehicle control technology, and in particular, to an intelligent driving control method and device, a vehicle, an electronic apparatus, a medium, and a product.

### BACKGROUND

With the increasing popularity of automobiles, traffic accidents have also increased. More than 20 million people worldwide are injured or maimed in traffic accidents each year, and more than 1 million people are killed, with economic losses amounting up to $500 billion. The road safety caused by road traffic accidents every year has greatly threatened the lives and property of the public and has become the focus of global attention. The analysis results of automobile traffic accidents show that 80% of the traffic accidents are caused by the driver's slow response and improper handling.

### SUMMARY

Embodiments of the present disclosure provide an intelligent driving control technology.

According to an aspect of the embodiments of the present disclosure, provided is an intelligent driving control method, comprising:

detecting a traffic signal of a vehicle travelling environment to obtain a detection result of the traffic signal;

acquiring a current travelling state of the vehicle and a vehicle default state corresponding to the detection result of the traffic signal;

determining whether the current travelling state of the vehicle matches the vehicle default state; and

in response to the current travelling state of the vehicle not matching the vehicle default state, outputting a driving alarm signal and/or a control signal for instructing the vehicle to switch from the current state to the vehicle default state.

According to an aspect of the embodiments of the present disclosure, provided is an intelligent driving control device, comprising:

a signal detection unit configured to detect a traffic signal of a vehicle travelling environment to obtain a detection result of the traffic signal;

a state acquisition unit configured to acquire a current travelling state of the vehicle and a vehicle default state corresponding to the detection result of the traffic signal;

a matching unit configured to determine whether the current travelling state of the vehicle matches the vehicle default state; and

a signal output unit configured to output a driving alarm signal and/or a control signal for instructing the vehicle to switch from the current state to the vehicle default state in response to the current travelling state of the vehicle not matching the vehicle default state.

According to another aspect of the embodiments of the present disclosure, provided is a vehicle, comprising the intelligent driving control device according to any one of the foregoing.

According to another aspect of the embodiments of the present disclosure, provided is an electronic apparatus, comprising a processor including the intelligent driving control device according to any one of the foregoing.

Optionally, the electronic apparatus may be an in-vehicle electronic apparatus.

According to another aspect of the embodiments of the present disclosure, provided is an electronic apparatus, comprising: a memory configured to store executable instructions; and

a processor configured to communicate with the memory to execute the executable instructions to complete operations of the intelligent driving control method according to any one of the foregoing.

Optionally, the electronic apparatus may be an in-vehicle electronic apparatus.

According to another aspect of the embodiments of the present disclosure, provided is a computer storage medium having computer-readable instructions stored thereon, which, when executed, execute operations of the intelligent driving control method according to any one of the foregoing.

According to another aspect of the embodiments of the present disclosure, provided is a computer program product including computer readable codes, and when the computer readable codes are run on an apparatus, a processor in the apparatus executes instructions for implementing the intelligent driving control method according to any one of the foregoing.

Based on the intelligent driving control method and device, vehicle, electronic apparatus, medium, product provided in the foregoing embodiments of the present disclosure, a traffic signal of a vehicle travelling environment is detected to obtain a detection result of the traffic signal; a current travelling state of the vehicle and a vehicle default state corresponding to the detection result of the traffic signal are acquired; whether the current travelling state of the vehicle matches the vehicle default state is determined; and in response to the current travelling state of the vehicle not matching the vehicle default state, a driving alarm signal and/or a control signal for instructing the vehicle to switch from the current state to the vehicle default state are/is outputted. The travelling state of the vehicle matches the default state of the traffic signal by means of the alarm signal and/or the control signal, which reduces the probability of problems such as violation of traffic regulations or occurrence of dangers caused by human mistakes or vehicle light indication errors or the like. For example, when the vehicle steers, failing to turn on a turn lamp or turning on the wrong turn lamp would mislead rear vehicles or rear pedestrians, and may cause a collision risk. By means of the alarm signal and/or the control signal provided by embodiments of the present disclosure, accurate signals are provided to rear vehicles or rear pedestrians, which reduces the probability of a collision risk, reduces the dangers of not stopping when the stopping is required and/or not steering when the steering is required caused by ignoring traffic signal indications, and improves the vehicle's travelling safety.

The technical solutions of the present disclosure are described in further detail below through the accompanying drawings and embodiments.

### BRIEF DESCRIPTION OF THE DRAWINGS

The accompanying drawings, which constitute a part of the specification, describe embodiments of the present disclosure, and, together with the description, serve to explain the principles of the present disclosure.

The present disclosure will be more clearly understood from the following detailed description with reference to the accompanying drawings, in which:

FIG. 1 is a flowchart schematically illustrating an intelligent driving control method according to an embodiment of the present disclosure;

FIG. 2 is a configuration diagram schematically illustrating an intelligent driving control device according to an embodiment of the present disclosure; and

FIG. 3 is a configuration diagram schematically illustrating an electronic apparatus suitable for implementing a terminal apparatus or a server according to an embodiment of the present disclosure.

### DETAILED DESCRIPTION

Various exemplary embodiments of the present disclosure will now be described in detail with reference to the accompanying drawings. It should be noted that the relative arrangements of the components and steps, the numerical expressions and numerical values set forth in these embodiments do not limit the scope of the present disclosure unless it is specifically stated otherwise.

Meanwhile, it should be understood that, for the convenience of description, the dimensions of the parts shown in the accompanying drawings are not drawn to actual scale.

The following description of at least one exemplary embodiment is in fact merely illustrative and is in no way to be construed as any limitation on present disclosure and its application or use.

The technologies, methods and apparatuses known to those of ordinary skill in the related art may not be discussed in detail, but, where appropriate, the described technologies, methods and apparatuses shall be considered as part of the specification.

It should be noted that similar reference numerals and letters denote similar terms in the following accompanying drawings, so that once a particular term is defined in one of the accompanying drawings, no further discussion is required in the subsequent accompanying drawings.

Embodiments of the present disclosure may be applied to a computer system/server, which may be operated together with many other general-purpose or special-purpose computing system environments or arrangements. Examples of well-known computing systems, environments and/or arrangements suitable for use with computer systems/servers include, but are not limited to, personal computer systems, server computer systems, thin clients, thick clients, handheld or laptop apparatuses, microprocessor-based systems, set-top boxes, programmable consumer electronics, network personal computers, small computer systems, large computer systems, and distributed cloud computing technology environments including any of the above systems, and so on.

Computer systems/servers may be described in the general context of computer system executable instructions, such as program modules, executed by computer systems. In general, program modules may include routines, programs, target programs, components, logics, data structures, and so forth that perform specific tasks or implement specific abstract data types. Computer systems/servers may be implemented in distributed cloud computing environments. In the distributed cloud computing environments, tasks are performed by remote processing apparatuses linked through communication networks. In the distributed cloud computing environments, program modules may be located on local or remote computing system storage media including storage apparatuses.

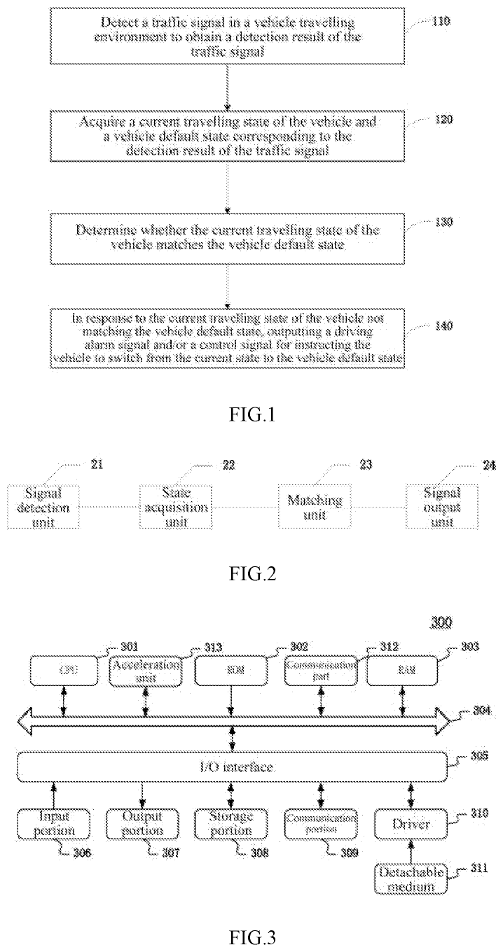

FIG. 1 is a flowchart schematically illustrating an intelligent driving control method according to an embodiment of the present disclosure. As shown in FIG. 1, the method of this embodiment comprises the following steps.

At step 110, a traffic signal in a vehicle travelling environment is detected to obtain a detection result of the traffic signal.

Optionally, in the travelling process of a vehicle, videos of the front and/or side of the vehicle are collected by at least one image collection device (such as a camera) provided at the front and/or side of the vehicle, and a continuous multi-frame image can be obtained by the collected videos. The term “continuous” may refer to each frame image in the temporally continuous videos; it may also be a multi-frame image with traffic signal obtained by traffic signal recognition. At this time, two consecutive frame images can be temporally discontinuous.

In one or more alternative embodiments, the traffic signal includes, but is not limited to, at least one of traffic light, traffic sign, lane line, and traffic police instruction.

Traffic signals refer to traffic commanding measures used to allocate right-of-way to traffic flows in time at places where traffic separation cannot be achieved on road intersections. The function of traffic signals is to scientifically distribute the right-of-way of vehicles and pedestrians on the road so that they can pass smoothly in an orderly manner. Vehicle travelling need to comply with traffic rules, and the traffic rules are mainly embodied by traffic signals during travelling. In the embodiment of the present disclosure, at least one traffic signal is collected to alert or control the vehicle to comply with traffic rules.

In an alternative example, step S110 may be executed by a processor by invoking corresponding instructions stored in a memory, or may be executed by a signal detection unit 21 run by the processor.

At step 120, a current travelling state of the vehicle and a vehicle default state corresponding to the detection result of the traffic signal are acquired.

The corresponding vehicle default state is obtained through the detection result of the detected traffic signal. The vehicle default state refers to a state of the vehicle corresponding to the traffic signal defaulted by a program or system without being changed by any other instructions. The current driving state of the vehicle can be obtained through vehicle state monitoring or vehicle instrument display.

In an alternative example, step S120 may be executed by the processor by invoking corresponding instructions stored in the memory, or may be executed by a state acquisition unit 22 run by the processor.

At step 130, whether the current travelling state of the vehicle matches the vehicle default state is determined.

Mismatch between the travelling state and the vehicle default state corresponding to the traffic signal would result in various dangers. In the process of travelling, driving authority of the vehicle gives priority to the driver, but manual operations are easy to be omitted or prone to mistakes. For example, a left turn is being performed, but the turn lamp is forgotten to be turned on or the right turn lamp is turned on. At this time, rear vehicles and/or rear pedestrians may proceed due to the wrong indication, which is prone to dangers such as collision. At this time, the driver needs to be alerted by the intelligent driving control method provided in the embodiment of the present disclosure or the vehicle needs to be controlled through control signals, so as to reduce the occurrence of dangerous situation.

In an alternative example, step S130 may be executed by the processor by invoking corresponding instructions stored in the memory, or may be executed by a matching unit 23 run by the processor.

At step 140, in response to the current travelling state of the vehicle not matching the vehicle default state, a driving alarm signal and/or a control signal for instructing the vehicle to switch from the current state to the vehicle default state are/is output.

In an alternative example, step S140 may be executed by the processor by invoking corresponding instructions stored in the memory, or may be executed by a signal output unit 24 run by the processor.

Based on the intelligent driving control method provided in the foregoing embodiment of the present disclosure, a traffic signal of a vehicle travelling environment is detected to obtain a detection result of the traffic signal; a current travelling state of the vehicle and a vehicle default state corresponding to the detection result of the traffic signal are acquired; whether the current travelling state of the vehicle matches the vehicle default state is determined; and in response to the current travelling state of the vehicle not matching the vehicle default state, a driving alarm signal and/or a control signal for instructing the vehicle to switch from the current state to the vehicle default state are/is outputted. The travelling state of the vehicle matches the default state of the traffic signal by means of the alarm signal and/or the control signal, which reduces the probability of problems such as violation of traffic regulations or occurrence of dangers caused by human mistakes or vehicle light indication errors or the like. For example, when the vehicle steers, failing to turn on a turn lamp or turning on the wrong turn lamp would mislead rear vehicles or rear pedestrians, and may cause a collision risk. By means of the alarm signal and/or the control signal provided by embodiments of the present disclosure, accurate signals are provided to rear vehicles or rear pedestrians, which reduces the probability of a collision risk, reduces the dangers of not stopping when the stopping is required and/or not steering when the steering is required caused by ignoring traffic signal indications, and improves the vehicle's travelling safety.

In one or more alternative embodiments, the current travelling state of the vehicle includes, but is not limited to, at least one of travelling speed, lamp state, direction control state, braking state, and horn state.

The vehicle in travelling may be controlled by a driver, and all states that affect travelling belong to vehicle travelling states. Optionally, the current travelling state of the vehicle includes at least one of travelling speed, lamp state, direction control state, braking state, and horn state. The embodiments of the present disclosure do not limit which travelling states are specifically included.

In one or more alternative embodiments, the detection result of the traffic signal includes, but is not limited to, a combination of one or more of the following: lane line departure detection result, traffic sign detection result, traffic light state detection result, and traffic police instruction detection result.

Different traffic signals have different detection results. For lane line, its detection result is usually an offset distance between the vehicle and the lane line. Traffic sign is a fixed type of identification information, and thus its detection result is a category of the traffic sign. Traffic light is dynamically changing identification information, and thus its detection result is a state of the traffic light. Traffic police instruction is also dynamically changing identification information, and thus its detection result is a state of a traffic police action, and can also be considered as classification result. The intelligent driving control of the vehicle can be realized through the detection result of the recognized traffic signal.

In one or more alternative embodiments, when the traffic signal is a traffic sign, step 110 may include:

collecting a video stream including the traffic sign by an image collection device provided on the vehicle;

performing the traffic sign classification on at least one frame image including the traffic sign in the video stream; and

obtaining the traffic sign detection result according to the classification result of traffic sign.

The vehicle will encounter various traffic signs during travelling, and different traffic signs have different meanings. While driving a vehicle, it is necessary to comply with the requirements of traffic signs. Therefore, in this embodiment, the image collection device acquires a video stream including the traffic sign, recognizes an image in the video stream to obtain a category of the traffic sign, and determines a driving operation that can be performed by the current vehicle based on the category of the traffic sign, thereby further improving the safety of intelligent driving.

Optionally, the traffic sign includes, but are not limited to, at least one of speed limit sign, prohibition sign, warning sign, instructing sign, road guiding sign, tourist area sign, and road construction safety sign.

Traffic signs are traffic facilities that direct, prohibit, warn or guide traffic by use of patterns, symbols, numbers and words. The traffic signs are generally set up on the roadside or above the road, so as to reflect traffic safety regulations. The traffic signs are beneficial to adjust traffic flow, regulate the traffic, and improve road capacity; the traffic signs are beneficial to predict road conditions and reduce traffic accidents; and the traffic signs are beneficial to save energy, reduce pollution and beautify roads.

For example, road traffic signs are divided into two major categories: main signs and auxiliary signs. In one alternative implementation, the main signs are divided into six types: warning signs, prohibition signs, instructing signs, road guiding signs, tourist area signs, and road construction safety signs. (1) Warning signs: signs that warn vehicles and pedestrians to pay attention to dangerous locations. There are 49 types of the warning signs. The colors are yellow for background, black for edge, and black for pattern, and the shapes include an equilateral triangle with the apex angle upward. (2) Prohibition signs: signs that prohibit or restrict traffic behavior of vehicles and pedestrians. There are 43 types of the prohibition signs. Except for individual signs, the colors of other signs are white for background, red for circle, red for bar, and black for pattern, with the pattern overlapping the bar; the shapes include a circle, an octagon, and an equilateral triangle with the apex angle downward. The prohibition signs are set up near road sections or road intersections where traffic behaviors of vehicles and pedestrians need to be prohibited or restricted. (3) Instructing signs: signs that guide vehicles and pedestrians to travel. There are 29 types of the instructing signs. The colors are blue for background and white for pattern; the shapes include a circle, a rectangle, and a square. The instructing signs are set up near road sections or road intersections where vehicles and pedestrians need to be guided to travel. (4) road guiding signs: signs that convey information about direction, location and distance of a road. There are 146 types of the road guiding signs. Except for milestones and 100-meter piles, the colors are blue for background and white for pattern; the colors of sign indicating highways are generally green for background and white for pattern. The shapes generally include a rectangular and a square except for the location identification signs, milestones, and diverging and merging signs. The road guiding signs are set up near road sections or road intersections that need to convey information about the direction, location and distance of a road. (5) Tourist area signs: signs that provide direction and distance of tourist attractions. There are 17 types of the tourist area signs. The colors are brown for background and white for character pattern; the shapes include a rectangular and a square. The tourist area signs can be divided into two categories: guide signs and tourism symbols, which are set up near road sections or road intersections that need to direct direction and distance of tourist attractions. (6) Road construction safety signs: signs that announce the passage of road construction areas. They are used to alert vehicle drivers and pedestrians. There are 26 types of the road construction safety signs. Among them, there are 20 types of road construction area signs for announcing the blockage and detour of the highways and general road traffic. The road construction safety signs are set up in an appropriate position in front of road sections such as road construction, maintenance, etc.

The auxiliary signs are signs set to maintain driving safety and smooth traffic when the main signs cannot fully express or indicates their contents. The auxiliary signs are white background, black character, black edge, and the shape can be a rectangle, which are attached under the main signs and play a role of auxiliary instructions.

Optionally, outputting the driving alarm signal and/or the control signal for instructing the vehicle to switch from the current state to the vehicle default state in response to the current travelling state of the vehicle not matching the vehicle default state includes at least one of the following.

In response to the category of the traffic sign being the speed limit sign, and the travelling state of the vehicle not matching the default travelling state corresponding to the speed limit sign, an instruction for controlling the speed of the vehicle to increase or decrease to the speed corresponding to the traffic sign is issued. In the vehicle default state corresponding to the speed limit sign, the vehicle speed can be controlled below the current signed speed. For example, if the speed on the speed limit sign is 60, the vehicle speed is controlled below 60 kilometers per hour in the corresponding vehicle default state.

In response to the category of traffic sign being the prohibition sign, and the travelling state of the vehicle not matching the default travelling state corresponding to the prohibition sign, an instruction for controlling the vehicle not to perform operations prohibited by the traffic sign is issued. In the vehicle default state corresponding to the prohibition sign, the vehicle can be controlled not to perform the instructions on the sign. For example, for no left turn sign, the vehicle is controlled not to turn left at current intersection.

In response to the category of traffic sign being the warning sign, and the travelling state of the vehicle not matching the default travelling state corresponding to the warning sign, an instruction for controlling the vehicle to change the driving state is issued. In the vehicle default state corresponding to the warning sign, the vehicle can be slowing down, etc. For example, if the road ahead is warned as a dangerous road section, the vehicle is controlled to slow down.

In response to the category of traffic sign being the instructing sign, and the travelling state of the vehicle not matching the default travelling state corresponding to the instructing sign, an instruction for controlling the vehicle to perform driving control according to instruction of the traffic sign is issued. In the vehicle default state corresponding to the instructing sign, the vehicle can be drove according to the guidance. For example, when it is guided to enter a highway from the entrance ahead, it is comprehensively determined whether the vehicle is drove according to the guidance in conjunction with the vehicle's destination at this time.

In response to the category of traffic sign being the road guiding sign and/or the tourist area sign, and the travelling state of the vehicle not matching the default travelling state corresponding to the road guiding sign and/or the tourist area sign, an instruction for controlling the vehicle to travel to a corresponding road in combination with a destination corresponding to the vehicle is issued.

In response to the category of traffic sign being the road construction safety sign, and the travelling state of the vehicle not matching the default travelling state corresponding to the road construction safety sign, an instruction is issued for controlling the vehicle to perform one or more of decelerating, braking, detouring, maintaining a driving state, slowing down, steering, turning on a turn lamp, and turning on a braking light according to instruction of the traffic sign.

For different types of traffic signs, different vehicle controls can be performed. For example, road traffic signs are detected in real time during normal travelling. The detected road traffic signs include: a variety of common speed limits such as 5, 15, 20, 30, 40, 50, 60, 70, 80, etc., the speed of the vehicle is controlled to reduce below the speed limit of the traffic sign at this time, that is, the speed of the vehicle is limited below 5 kilometers per hour, below 15 kilometers per hour, below 20 kilometers per hour, below 30 kilometers per hour, below 40 kilometers per hour, below 50 kilometers per hour, below 60 kilometers per hour, below 70 kilometers per hour and below 80 kilometers per hour; and prohibition signs, such as no left turn, no right turn, no steering, no turns and no stopping, the vehicle is controlled not to perform operations prohibited by the traffic signs at this time, and if the driver performs these prohibited operations, a warning information can be issued and/or an automatic control can be performed to prohibit these operations.

In one or more optional embodiments, when the target object is a lane line, step 110 may include:

collecting a video stream including a travelling road by an image collection device provided on a vehicle;

performing a lane line detection on at least one frame image in the video stream; and

obtaining a lane line departure detection result according to a result of the lane line detection and a relative position information of the vehicle.

Optionally, since the lane line is set on the road surface, when collecting a video steam, it is necessary to collect the video stream including the travelling road, and a deep neural network can be used to detect the lane line in the image. For example, the lane line in the image is recognized through an image recognition network to obtain the position of the lane line in the image, and the relative position information between the vehicle and the lane line is determined in combination with the position of the lane line in a multi-frame continuous image. The relative position information may include, but is not limited to, crossing over the line, left deviation, right deviation, centering etc. The obtained lane line departure detection result can reduce occurrence of violation operations of the vehicle such as crossing over the line.

Optionally, step 140 may include:

in response to the current travelling state of the vehicle not matching the vehicle default state corresponding to the lane line departure detection result, issuing a prompt information for turning on a turn lamp and/or controlling the vehicle to turn on the corresponding turn lamp according to the default travelling state corresponding to the lane line departure detection result;

when the relative position information between the vehicle and the lane line is recognized and it is determined that the vehicle needs to steer, acquiring information on the turn lamp state of the vehicle, and in a case that the detection result of the lane line indicates that the vehicle is in the process of steering or starts steering, if the turn lamp in the vehicle is not turned on or incorrectly turned on at this time, the prompt information and/or the control information are/is issued, so that the turn lamp in the vehicle corresponding to the detection result is turned on to reduce the probability of collision with a rear vehicle.

Or, step 140 may include:

in response to the current travelling state of the vehicle not matching the vehicle default state corresponding to the lane line departure detection result, and a change trend of the lane line departure detection result indicating that a degree of lane line departure remains or increases, issuing a prompt information for turning on a turn lamp and/or controlling the vehicle to turn on the corresponding turn lamp according to the default travelling state corresponding to the lane line departure detection result.

At this time, it means that the vehicle has been deviated in the same direction, and such operation should be considered as steering. A prompt for turning on the turn lamp can be issued or the turn lamp can be automatically controlled to turn on, so as to ensure that a driving trajectory of the present vehicle can be recognized by other vehicles and reduce the occurrence of danger.

Optionally, issuing a prompt information for turning on a turn lamp and/or controlling the vehicle to turn on the corresponding turn lamp according to the default travelling state corresponding to the lane line departure detection result includes:

determining to issue the prompt information for turning on the turn lamp and/or control the vehicle to turn on the corresponding turn lamp in conjunction with the detection result of traffic signs and/or the detection result of state of traffic lights.

Optionally, when the vehicle needs to steer, in addition to the information on the lane line, it is necessary to observe a current state of the traffic light and/or a category of the traffic sign. If the current steering required is contradictory to the state of traffic light and/or the category of traffic sign, the steering will be prohibited, and the vehicle will be adjusted to the normal route. Only if the state of traffic light and the category of traffic sign match, the prompt information for turning on the turn lamp and/or controlling the vehicle to turn on the corresponding turn lamp is executed.

Optionally, outputting the driving alarm signal and/or the control signal for instructing the vehicle to switch from the current state to the vehicle default state in response to the current travelling state of the vehicle not matching the vehicle default state includes:

in response to the current travelling state of the vehicle not matching the vehicle default state corresponding to the lane line departure detection result, acquiring a fluctuation range of a distance between the vehicle and the lane line; and

in response to the fluctuation range exceeding a safe distance range within a duration of a set threshold for an alarm time, outputting a driving alarm signal and/or controlling the vehicle to keep the distance between the vehicle and the lane line within the safe distance range.

In the embodiment of the present disclosure, the distance between the vehicle and the lane line is in a fluctuating state, which indicates that the driving is in an unstable state. The driver constantly deviates to the left or right during the process of adjustment, which is prone to danger. The distance between the vehicle and the lane line is controlled within a stable safe distance range by means of automatic control, thereby improving driving safety.

Optionally, the default travelling state corresponding to the detection result is determined based on the relative position information and the type of lane line. The types of lane line include, but are not limited to, at least one of the following: broken white line, solid white line, broken yellow line, solid yellow line, double broken white line, double solid yellow line, solid yellow line with broken yellow line, and double solid white line.

Optionally, the type of lane line may include, but are not limited to, broken white line, solid white line, broken yellow line, solid yellow line, double broken white line, double solid yellow line, solid yellow line with broken yellow line, and double solid white line and so on. Different types of lane lines correspond to different guidance modes. Specifically, the broken white line, when drawn in a road segment, is used to separate traffic flows traveling in the same direction or is used as an identification line for driving safety distance; and the broken white line, when drawn at a road intersection, is used to guide the vehicle to travel. The solid white line, when drawn in a road segment, is used to separate motor vehicles and non-motor vehicles traveling in the same direction, or indicate edges of a lane; and the solid white line, when drawn at a road intersection, is used as a guide lane line or a stop line. The broken yellow line, when drawn in a road segment, is used to separate traffic flows of opposite direction, and when drawn on a roadside or a curb, is used to prohibit the vehicle from stopping on the roadside for a long time. The solid yellow line, when drawn in a road segment, is used to separate traffic flows of opposite direction, and when drawn on a roadside or a curb, is used to prohibit the vehicle from stopping on the roadside for a long time or temporarily. The double broken white line, when drawn at the intersection, is used as a slowdown and yield line, and when drawn in a road segment, is used as a variable lane line in which driving direction changes over time. The double solid yellow line, when drawn in a road segment, is used to separate traffic flows of opposite direction. The solid yellow line with broken yellow line, when drawn in a road segment, is used to separate traffic flows of opposite direction; vehicle overtaking, crossing or turning around is prohibited on the solid yellow line side, and vehicle overtaking, crossing or turning around is permitted under safe conditions on the broken yellow line side. The double solid white line, when drawn at a road intersection, is used as a stop and yield line.

Optionally, lane lines include traffic markings on both sides of the lane, stop lines and turning guide lines.

According to functional classification, lane lines may include traffic markings on both sides of the lane, stop lines and turning guide lines. Specifically, traffic markings on both sides of the lane are used to limit left and right distances of the vehicle and reduce the probability of inter-vehicle friction and/or collision between different lanes. Stop lines are used to limit the passage of vehicles and reduce the possibility of danger in hazardous areas. Turning guide lines restricts the vehicle to steer in the specified route, which reduces the possibility of conflict between the straight-going vehicle and the turning vehicle. For dangerous traffic situations, each type of different lane line corresponds to a different vehicle default state.

In one or more alternative embodiments, when the target object is a traffic light, step 110 may include:

acquiring a video stream including the traffic light by an image collection device provided on the vehicle; and

performing a traffic light state detection on at least one frame image in the video stream, and determining the result of the traffic light state detection.

Optionally, the state of traffic light may include, but is not limited to, distinguishing traffic lights by color and/or shape, for example, distinguishing traffic lights by color includes states such as red light state, green light state and yellow light state, and distinguishing traffic lights by shape includes shapes such as go-straight, left-turn, right-turn and turn-around. In order to more comprehensively perform intelligent control on the vehicle, in addition to the relative position information between the lane line and the vehicle, state of traffic lights can be obtained. The safety performance of the vehicle can be further improved by intelligently controlling the vehicle according to the state of traffic lights.

Optionally, step 140 may include:

in response to the current travelling state of the vehicle not matching the default travelling state corresponding to the result of traffic light state detection, outputting a driving alarm signal and/or outputting an instruction for controlling the vehicle to turn on the turn lamp, decelerate, brake and/or steer.

According to current traffic regulations, colors of traffic lights include red, green and yellow, and different colors correspond to different traffic states. Red indicates that passages of vehicles and/or pedestrians are prohibited, green indicates that passages of vehicles and/or pedestrians are permitted, and yellow indicates that passages of vehicles and/or pedestrians needs to be suspended. Items that assist the colors may also include shapes of traffic signals or the like. For example, a plus shape (an optional first preset shape) indicates that passage is permitted, a cross shape (an optional second preset shape) indicates that passage is prohibited, and a minus shape (an optional third preset shape) indicates waiting state, and so on. The embodiments of the present disclosure provide different coping strategies for different states of traffic lights, so as to realize automatic and semi-automatic intelligent driving and improve driving safety.

Colors of traffic lights include red, yellow and green, and shapes include arrows, circles or other shapes. For traffic lights of different shapes, signals may not be accurately recognized if only positions of the traffic lights are recognized. Therefore, in this embodiment, at least two of the location area, color and shape are recognized. For example, when the location area and color of the traffic light are determined, the position at which the current traffic light is located in the image (corresponding to which direction of the vehicle) can be determined, and it can be determined by color the displayed state of the traffic light (red, green or yellow respectively corresponding to different states). Assisted driving or automatic driving can be achieved through the recognized different states of traffic lights. When the location area and shape of the traffic light are determined, the position at which the current traffic light is located in the image (corresponding to which direction of the vehicle) can be determined, and it can be determined by shape the displayed state of the traffic light (e.g., arrows in different directions indicate different states, or different shapes of human figures indicate different states). When the color and shape of the traffic light are determined, the current states of traffic light can be determined based on the combination of color and shape (e.g., green arrows pointing to the left indicate turning left and passing through, and red arrows pointing to the front indicate no traffic ahead). When the location area, color and shape of traffic lights are determined, on a basis of the obtained position at which the current traffic light is located in the image, the current state of traffic light can be determined according to a combination of color and shape. In this embodiment, the attribute features of traffic lights can be more prominent by combining two or more of the three attributes, which is beneficial to improve the effect of the processing such as detection and recognition.

In one or more alternative embodiments, when the target object is a traffic police instruction, step 110 may include:

collecting a video stream including a traffic police by an image collection device provided on the vehicle; and

performing the traffic police instruction detection on at least one frame image in the video stream to obtain the traffic police instruction detection result.

In addition to fixed traffic lights, traffic signs and lane line, vehicles will also encounter some sudden situations (e.g., the traffic lights are turned off) during travelling on roads. At this time, the traffic polices usually maintain traffic order. Information on traffic police needs to be collected and acquired for identification, and vehicles are controlled in accordance with instructions of traffic police to ensure safety of vehicle travelling. Optionally, the position and gesture of the traffic police can be captured by operation, and the commanding gesture signal of the traffic police is fixed. These gesture signals can be captured by setting, the traffic police instruction can be detected, and corresponding detection results can be obtained.

Optionally, outputting the driving alarm signal and/or the control signal for instructing the vehicle to switch from the current state to the vehicle default state in response to the current travelling state of the vehicle not matching the vehicle default state includes:

in response to the current travelling state of the vehicle not matching the vehicle default state corresponding to the traffic police instruction detection result, outputting the driving alarm signal and/or an instruction control signal which is based on the default travelling state corresponding to the traffic police instruction detection result, the instruction control signal including, but being not limited to, one of the following: prompt information for turning on a turn lamp, controlling the vehicle to turn on the corresponding turn lamp, controlling the vehicle to steer, controlling the vehicle to brake, and controlling the vehicle to stop.

There are 8 kinds of traffic police commanding gesture signals, namely, stopping, going-straight, left turning, left-turn waiting, right turning, lane changing, slowing down and pulling over. Usually in the case that a traffic police commands vehicles, vehicle should be travelled in accordance with gestures of the traffic police rather than the other three traffic signals.

Different commanding gesture signals have different vehicle default states. The vehicle default state corresponding to a stop gesture signal is to stop the vehicle. The vehicle default state corresponding to a go-straight gesture signal is to keep going straight without turning. The vehicle default state corresponding to a left turn gesture signal is to turn left and turn on the left turn lamp. The vehicle default state corresponding to a left turn waiting is to brake and wait and turn on the left turn lamp. The vehicle default state corresponding to a right-turn gesture signal is to turn right and turn on the right turn lamp. The vehicle default state corresponding to a lane changing gesture signal is to turn on the turn lamp and change to the corresponding lane. The vehicle default state corresponding to a slow down gesture signal is to control the vehicle to reduce the speed. The vehicle default state corresponding to a pull over gesture signal is to turn on the right turn lamp and pull over on the roadside. By the correspondence between the commanding gesture signal and the vehicle default state, a corresponding vehicle default state can be obtained after the traffic police instruction detection result on the commanding gesture signal is recognized, so as to determine whether the travelling state of the vehicle matches the commanding gesture signal. In the embodiment of the present disclosure, for the case of mismatch, the driving alarm signal and/or the instruction control signal are output to reduce situations of vehicles violating traffic police commands.

A person of ordinary skill in the art can understand that all or some of the steps for implementing the above method embodiments may be completed by a hardware related to a program instruction, the foregoing program may be stored in a computer readable storage medium, and the program, when executed, executes the steps including the above method embodiments. The foregoing storage media include any media that can store program codes, such as ROM, RAM, CD or CD-ROM, etc.

FIG. 2 is a configuration diagram schematically illustrating an embodiment of an intelligent driving control device according to an embodiment of the present disclosure. The device of this embodiment may be configured to implement the above method embodiments in the present disclosure. As shown in FIG. 2, the device of this embodiment includes the following units:

A signal detection unit 21 configured to detect a traffic signal in a vehicle travelling environment to obtain a detection result of the traffic signal;

A state acquisition unit 22 configured to acquire a current travelling state of the vehicle and a vehicle default state corresponding to the detection result of the traffic signal,

The corresponding vehicle default state is obtained through the detection result of the detected traffic signal, the vehicle default state refers to a state of the vehicle corresponding to the traffic signal defaulted by a program or system without being changed by any other instructions, and the current travelling state of the vehicle can be obtained through vehicle state monitoring or vehicle instrument display;

A matching unit 23 configured to determine whether the current travelling state of the vehicle matches the vehicle default state,

Mismatch between the travelling state and the vehicle default state corresponding to the traffic signal would result in various dangers. In the process of travelling, driving authority of the vehicle gives priority to the driver, but manual operations are easy to be omitted or prone to mistakes. For example, a left turn is being performed, but the turn lamp is forgotten to be turned on or the right turn lamp is turned on. At this time, rear vehicles and/or rear pedestrians may proceed due to the wrong indication, which is prone to dangers such as collision. At this time, the driver needs to be alerted by the intelligent driving control method provided in the embodiment of the present disclosure or the vehicle needs to be controlled through control signals, so as to reduce the occurrence of dangerous situation.

A signal output unit 24 configured to outputting a driving alarm signal and/or a control signal for instructing the vehicle to switch from the current state to the vehicle default state, in response to the current travelling state of the vehicle not matching the vehicle default state.

Based on the intelligent driving control device provided in the above-mentioned embodiments of the present disclosure, the travelling state of the vehicle matches the default state of the traffic signal by means of the alarm signal and/or the control signal, which reduces the probability of problems such as violation of traffic regulations or occurrence of dangers caused by human mistakes or vehicle light indication errors or the like. For example, when the vehicle steers, failing to turn on a turn lamp or turning on the wrong turn lamp would mislead rear vehicles or rear pedestrians, and may cause a collision risk. By means of the alarm signal and/or the control signal provided by embodiments of the present disclosure, accurate signals are provided to rear vehicles or rear pedestrians, which reduces the probability of a collision risk, reduces the dangers of not stopping when the stopping is required and/or not steering when the steering is required caused by ignoring traffic signal indications, and improves the vehicle's travelling safety.

In one or more alternative embodiments, the traffic signal includes, but is not limited to, at least one of traffic light, traffic sign, lane line, and traffic police instruction.

Traffic signals refer to traffic commanding measures used to allocate right-of-way to traffic flows in time at places where traffic separation cannot be achieved on road intersections. The function of traffic signals is to scientifically distribute the right-of-way of vehicles and pedestrians on the road so that they can pass smoothly in an orderly manner. Vehicle travelling need to comply with traffic rules, and the traffic rules are mainly embodied by traffic signals during travelling. In the embodiment of the present disclosure, at least one traffic signal is collected to alert or control the vehicle to comply with traffic rules.

In one or more alternative embodiments, the current travelling state of the vehicle includes, but is not limited to, at least one of travelling speed, lamp state, direction control state, braking state, and horn state.

The vehicle in travelling may be controlled by a driver, and all states that affect travelling belong to vehicle travelling states. Optionally, the current travelling state of the vehicle includes at least one of travelling speed, lamp state, direction control state, braking state, and horn state. The embodiments of the present disclosure do not limit which travelling states are specifically included.

In one or more alternative embodiments, the detection result of traffic signal includes a combination of one or more of the following: lane line departure detection result, traffic sign detection result, traffic light state detection result, traffic police instruction detection result.

Different traffic signals have different detection results. For lane line, its detection result is usually an offset distance between the vehicle and the lane line. Traffic sign is a fixed type of identification information, and thus its detection result is a category of the traffic sign. Traffic light is dynamically changing identification information, and thus its detection result is a state of the traffic light. Traffic police instruction is also dynamically changing identification information, and thus its detection result is a state of a traffic police action, and can also be considered as classification result. The intelligent driving control of the vehicle can be realized through the detection result of the recognized traffic signal.

In one or more optional embodiments, when the traffic signal is a traffic sign, the signal detection unit 21 is configured to collect a video stream including the traffic sign by an image collection device provided on the vehicle; perform the traffic sign classification on at least one frame image including the traffic sign in the video stream; and obtain the traffic sign detection result according to a classification result of the traffic sign.

The vehicle will encounter various traffic signs during travelling, and different traffic signs have different meanings. While driving a vehicle, it is necessary to comply with the requirements of traffic signs. Therefore, in this embodiment, the image collection device acquires a video stream including the traffic sign, recognizes an image in the video stream to obtain a category of the traffic sign, and determines a driving operation that can be performed by the current vehicle based on the category of the traffic sign, thereby further improving the safety of intelligent driving.

Optionally, the traffic sign includes, but are not limited to, at least one of speed limit sign, prohibition sign, warning sign, instructing sign, road guiding sign, tourist area sign, and road construction safety sign.

Optionally, the signal output unit is configured to perform at least one of the following operations:

in response to the category of the traffic sign being the speed limit sign, and the travelling state of the vehicle not matching the default travelling state corresponding to the speed limit sign, an instruction for controlling the speed of the vehicle to increase or decrease to the speed corresponding to the traffic sign is issued;

in response to the category of traffic sign being the prohibition sign, and the travelling state of the vehicle not matching the default travelling state corresponding to the prohibition sign, an instruction for controlling the vehicle not to perform operations prohibited by the traffic sign is issued;

in response to the category of traffic sign being the warning sign, and the travelling state of the vehicle not matching the default travelling state corresponding to the warning sign, an instruction for controlling the vehicle to change the driving state is issued;

in response to the category of traffic sign being the instructing sign, and the travelling state of the vehicle not matching the default travelling state corresponding to the instructing sign, an instruction for controlling the vehicle to perform driving control according to instruction of the traffic sign is issued;

in response to the category of traffic sign being the road guiding sign and/or the tourist area sign, and the travelling state of the vehicle not matching the default travelling state corresponding to the road guiding sign and/or the tourist area sign, an instruction for controlling the vehicle to travel to a corresponding road in combination with a destination corresponding to the vehicle is issued; and

in response to the category of traffic sign being the road construction safety sign, and the travelling state of the vehicle not matching the default travelling state corresponding to the road construction safety sign, an instruction is issued for controlling the vehicle to perform one or more of decelerating, braking, detouring, maintaining a driving state, slowing down, steering, turning on a turn lamp, and turning on a braking light according to instruction of the traffic sign.

In one or more optional embodiments, when the target object is a lane line, the signal detection unit 21 is configured to collect a video stream including a travelling road by an image collection device provided on a vehicle, perform a lane line detection on at least one frame image in the video stream, and obtain a lane line departure detection result according to a result of the lane line detection and a relative position information of the vehicle.

Optionally, since the lane line is set on the road surface, when collecting a video steam, it is necessary to collect the video stream including the travelling road, and a deep neural network can be used to detect the lane line in the image. For example, the lane line in the image is recognized through an image recognition network to obtain the position of the lane line in the image, and the relative position information between the vehicle and the lane line is determined in combination with the position of the lane line in a multi-frame continuous image. The relative position information may include, but is not limited to, crossing over the line, left deviation, right deviation, centering etc. The obtained lane line departure detection result can reduce occurrence of violation operations of the vehicle such as crossing over the line.

Optionally, the signal output unit 24 is configured to, in response to the current travelling state of the vehicle not matching the vehicle default state corresponding to the lane line departure detection result, or in response to the current travelling state of the vehicle not matching the vehicle default state corresponding to the lane line departure detection result, and a change trend of the lane line departure detection result indicating that a degree of lane line departure remains or increases, issue a prompt information for turning on a turn lamp and/or control the vehicle to turn on the corresponding turn lamp according to the default travelling state corresponding to the lane line departure detection result.

Optionally, the signal output unit 24 is configured to, when issuing a prompt information for turning on a turn lamp and/or controlling the vehicle to turn on the corresponding turn lamp according to the default travelling state corresponding to the lane line departure detection result, determine to issue the prompt information for turning on the turn lamp and/or control the vehicle to turn on the corresponding turn lamp in conjunction with the detection result of traffic signs and/or the detection result of state of traffic lights.

Optionally, the signal output unit 24 is configured to, in response to the current travelling state of the vehicle not matching the vehicle default state corresponding to the lane line departure detection result, acquire a fluctuation range of a distance between the vehicle and the lane line; and in response to the fluctuation range exceeding a safe distance range within a duration of a set threshold for an alarm time, output a driving alarm signal and/or control the vehicle to keep the distance between the vehicle and the lane line within the safe distance range.

Optionally, the default travelling state corresponding to the detection result is determined based on the relative position information and the type of lane line. The types of lane line include, but are not limited to, at least one of the following: broken white line, solid white line, broken yellow line, solid yellow line, double broken white line, double solid yellow line, solid yellow line with broken yellow line, and double solid white line.

Optionally, lane lines include traffic markings on both sides of the lane, stop lines and turning guide lines.

In one or more optional embodiments, when the target object is a traffic light, the signal detection unit 21 is configured to: acquire a video stream including the traffic light by an image collection device provided on the vehicle; and perform a traffic light state detection on at least one frame image in the video stream, and determining the result of the traffic light state detection.

Optionally, the state of traffic light may include, but is not limited to, distinguishing traffic lights by color and/or shape, for example, distinguishing traffic lights by color includes states such as red light state, green light state and yellow light state, and distinguishing traffic lights by shape includes shapes such as go-straight, left-turn, right-turn and turn-around. In order to more comprehensively perform intelligent control on the vehicle, in addition to the relative position information between the lane line and the vehicle, state of traffic lights can be obtained. The safety performance of the vehicle can be further improved by intelligently controlling the vehicle according to the state of traffic lights.

Optionally, the signal output unit 24 is configured to, in response to the current travelling state of the vehicle not matching the default travelling state corresponding to the result of traffic light state detection, output a driving alarm signal and/or outputting an instruction for controlling the vehicle to turn on the turn lamp, decelerate, brake and/or steer.

Optionally, when the target object is a traffic police instruction, the signal detection unit 21 is configured to: collect a video stream including a traffic police by an image collection device provided on the vehicle; and perform the traffic police instruction detection on at least one frame image in the video stream to obtain the traffic police instruction detection result.

Optionally, the signal output unit is configured to in response to the current travelling state of the vehicle not matching the vehicle default state corresponding to the traffic police instruction detection result, outputting the driving alarm signal and/or an instruction control signal which is based on the default travelling state corresponding to the traffic police instruction detection result, the instruction control signal including, but being not limited to, one of the following: prompt information for turning on a turn lamp, controlling the vehicle to turn on the corresponding turn lamp, controlling the vehicle to steer, controlling the vehicle to brake, and controlling the vehicle to stop.

For the operation process, setting manner and corresponding technical effect of any embodiment of the intelligent driving control device provided by the embodiments of the present disclosure, reference may be made to specific descriptions of the foregoing corresponding method embodiments of the present disclosure. Due to the limited space, details are not described herein again.

According to another aspect of the embodiments of the present disclosure, there is provided a vehicle comprising the intelligent driving control device according to any one of the foregoing embodiments.

According to another aspect of the embodiments of the present disclosure, there is provided an electronic apparatus comprising a processor including the intelligent driving control device according to any one of the foregoing embodiments.

Optionally, the electronic apparatus can be an in-vehicle electronic apparatus.

According to another aspect of the embodiments of the present disclosure, there is provided an electronic apparatus comprising:

a memory configured to store executable instructions; and

a processor configured to communicate with the memory to execute the executable instructions to complete operations of the intelligent driving control method according to any one of the foregoing embodiments.

Optionally, the electronic apparatus can be an in-vehicle electronic apparatus.

According to another aspect of the embodiments of the present disclosure, there is provided a computer readable storage medium having computer-readable instructions stored thereon, which, when executed, perform operations of the intelligent driving control method according to any one of the foregoing embodiments.

According to another aspect of the embodiments of the present disclosure, there is provided a computer program product comprising computer readable codes, when the computer readable codes are run on an apparatus, a processor in the apparatus executes instructions for implementing the intelligent driving control method according to any one of the foregoing embodiments.

Embodiments of the present disclosure further provide an electronic apparatus, which can be, for example, a mobile terminal, a personal computer (PC), a tablet computer, a server, or the like. The following refers to FIG. 3, which shows a configuration diagram schematically illustrating an electronic apparatus 300 suitable for implementing a terminal apparatus or server of the embodiments of the present disclosure. As shown in FIG. 3, the electronic apparatus 300 includes one or more processors and a communication part etc. The one or more processors are for example one or more central processing units (CPUs) 301 and/or one or more dedicated processors, and the dedicated processors may serve as acceleration units 313, including but not limited to dedicated processors such as image processing units (GPUs), FPGAs, DSPs, and other ASIC chips. The processor can execute various appropriate operations and processes according to the executable instructions stored in a read-only memory (ROM) 302 or the executable instructions loaded from a storage portion 308 into a random access memory (RAM) 303. A communication part 312 may include but is not limited to a network card, which may include but is not limited to an IB (Infiniband) network card.

The processor can communicate with the read-only memory 302 and/or the random access memory 303 to execute executable instructions, connect with the communication part 312 by using a bus 304, and communicate with other target apparatuses via the communication part 312, so as to complete operations corresponding to any method provided in the embodiments of the present disclosure. For example, a traffic signal in a vehicle travelling environment is detected to obtain a detection result of the traffic signal; a current travelling state of the vehicle and a vehicle default state corresponding to the detection result of the traffic signal are acquired; whether the current travelling state of the vehicle matches the vehicle default state is determined; and in response to the current travelling state of the vehicle not matching the vehicle default state, a driving alarm signal and/or a control signal for instructing the vehicle to switch from the current state to the vehicle default state is/are outputted.

In addition, a variety of programs and data required for device operation can also be stored in the RAM 303. The CPU 301, ROM 302 and RAM 303 are connected to each other by the bus 304. In the case of having RAM 303, ROM 302 is an optional module. The RAM 303 stores executable instructions or writes executable instructions to the ROM 302 at runtime, and the executable instructions cause the central processing unit 301 to perform operations corresponding to the communication method described above. An input/output (I/O) interface 305 is also connected to the bus 304. The communication part 312 may be integratedly provided, or may be provided as multiple sub-modules (e.g., multiple IB network cards) and are on the bus link.

The following components are connected to the I/O interface 305: an input portion 306 including a keyboard, a mouse, etc.; an output portion 307 including a cathode ray tube (CRT), a liquid crystal display (LCD), and a speaker, etc.; a storage portion 308 including a hard disk, etc.; and a communication portion 309 including network interface cards such as a LAN card, a modem, etc. The communication portion 309 performs communication processing via a network such as the Internet. The driver 310 is also connected to the I/O interface 305 as needed. Detachable medium 311 such as magnetic disks, optical disks, magneto-optical disks, semiconductor memories are installed on the driver 310 as needed to facilitate the installation of computer programs read from it into storage section 308 as needed.

It should be noted that the architecture shown in FIG. 3 is only an alternative implementation. In a specific implementation, the number and type of components shown in FIG. 3 may be selected, deleted, added or replaced as required. Different functional component settings may also be implemented in separate settings or integrated settings. For example, the acceleration unit 313 and the CPU 301 may be provided separately, or the acceleration unit 313 may be integrated on the CPU 301, and the communication part may be provided separately, or may be integrated on the CPU 301 or the acceleration unit 313, or the like. These alternative embodiments all fall within the scope of the present disclosure.

In particular, according to embodiments of the present disclosure, the process described above with reference to the flowchart may be implemented as a computer software program. For example, an embodiment of the present disclosure includes a computer program product, which includes a computer program tangibly included in a machine readable medium. The computer program includes program codes used to execute the method shown in the flowchart. The program codes may include instructions corresponding to the method steps provided in the embodiment of the present disclosure. For example, a traffic signal in a vehicle travelling environment is detected to obtain a detection result of the traffic signal; a current travelling state of the vehicle and a vehicle default state corresponding to the detection result of the traffic signal are acquired; whether the current travelling state of the vehicle matches the vehicle default state is determined; and in response to the current travelling state of the vehicle not matching the vehicle default state, a driving alarm signal and/or a control signal for instructing the vehicle to switch from the current state to the vehicle default state is/are outputted. In such an embodiment, the computer program may be downloaded and installed from the network via communication portion 309 and/or installed from the detachable medium 311. Such computer program, when executed by the central processing unit (CPU) 301, performs operations of the above functions defined in the method of the present disclosure.

Each of the embodiments in this specification is described in a progressive manner. Each embodiment focuses on the differences from other embodiments, and the same or similar parts between the embodiments can be referred to each other. For the system embodiment, since it basically corresponds to the method embodiment, its description is relatively simple. For the relevant parts, please refer to the description of the method embodiment.

The method and device of the present disclosure may be implemented in many ways. For example, the method and device of the present disclosure may be implemented by software, hardware, and firmware or any combination of software, hardware, and firmware. The above sequence of steps for the described method is for illustration only, and the steps of the method of the present disclosure are not limited to the above sequence, unless otherwise specified. In addition, in some embodiments, present disclosure may also be implemented as a program recorded in a recording medium, including machine readable instructions for implementing the method according to present disclosure. Thus, present disclosure also covers a recording medium for storing a program for executing the method according to present disclosure.

The description of present disclosure is given for the sake of example and description, and is not exclusive or limited to the form disclosed. Many modifications and changes are apparent to those of ordinary skill in the art. The selection and description of embodiments are intended to better illustrate principles and practical applications of present disclosure and to enable those of ordinary skill in the art to understand present disclosure so as to design various embodiments with various modifications suitable for specific uses.

What is claimed is:

1. An intelligent driving control method, comprising:
detecting a traffic signal of a vehicle travelling environment to obtain a detection result of the traffic signal;
acquiring a current travelling state of a vehicle and a vehicle default state corresponding to the detection result of the traffic signal;
determining whether the current travelling state of the vehicle matches the vehicle default state; and
in response to the current travelling state of the vehicle not matching the vehicle default state, outputting a driving alarm signal and/or a control signal for instructing the vehicle to switch from a current state to the vehicle default state.

2. The method according to claim 1,wherein the traffic signal comprises at least one of a traffic light, a traffic sign, a lane line, and a traffic police instruction.

3. The method according to claim 1, wherein the current travelling state of the vehicle comprises at least one of a travelling speed, a lamp state, a direction control state, a braking state, and a horn state.

4. The method according to claim 1, wherein the detection result of the traffic signal comprises a combination of one or more of a lane line departure detection result, a traffic sign detection result, a traffic light state detection result, and a traffic police instruction detection result.

5. The method according to claim 4, wherein when the traffic signal is a traffic sign, detecting the traffic signal of the vehicle travelling environment to obtain the detection result of the traffic signal comprises:
collecting a video stream including the traffic sign by an image collection device provided on the vehicle;
performing a traffic sign classification on at least one frame image including the traffic sign in the video stream; and
obtaining the traffic sign detection result according to the classification result of the traffic sign.

6. The method according to claim 5, wherein the traffic sign comprises at least one of a speed limit sign, a prohibition sign, a warning sign, an instructing sign, a road guiding sign, a tourist area sign, and a road construction safety sign.

7. The method according to claim 5, wherein in response to the current travelling state of the vehicle not matching the vehicle default state, outputting the driving alarm signal and/or the control signal for instructing the vehicle to switch from the current state to the vehicle default state comprises at least one of the operations:
in response to the category of the traffic sign being a speed limit sign, and the current travelling state of the vehicle not matching the default travelling state corresponding to the speed limit sign, issuing an instruction for controlling a speed of the vehicle to increase or decrease to the speed corresponding to the traffic sign;
in response to the category of the traffic sign being a prohibition sign, and the current travelling state of the vehicle not matching the default travelling state corresponding to the prohibition sign, issuing an instruction for controlling the vehicle not to perform operations prohibited by a traffic sign;
in response to the category of the traffic sign being a warning sign, and the current travelling state of the vehicle not matching the default travelling state corresponding to the warning sign, issuing an instruction for controlling the vehicle to change a driving state;
in response to the category of the traffic sign being an instructing sign, and the current travelling state of the vehicle not matching the default travelling state corresponding to the instructing sign, issuing an instruction for controlling the vehicle to perform drive control according to instruction of the traffic sign;
in response to the category of the traffic sign being a road guiding sign and/or a tourist area sign, and the current travelling state of the vehicle not matching the default travelling state corresponding to the road guiding sign and/or the tourist area sign, issuing an instruction for controlling the vehicle to travel toward a corresponding road according to a destination corresponding to the vehicle; and
in response to the category of the traffic sign being a road construction safety sign, and the current travelling state of the vehicle not matching the default travelling state corresponding to the road construction safety sign, issuing an instruction for controlling the vehicle to perform one or more of decelerating, braking, detouring, maintaining the travelling state, slowing down, steering, turning on a turn lamp, and turning on a braking lamp according to instruction of the traffic sign.

8. The method according to claim 4, wherein when a target object is a lane line, detecting the traffic signal of the vehicle travelling environment to obtain the detection result of the traffic signal comprises:
collecting a video stream including a travelling road by an image collection device provided on the vehicle;
performing a lane line detection on at least one frame image in the video stream; and
obtaining the lane line departure detection result according to a result of the lane line detection and a relative position information of the vehicle.

9. The method according to claim 8, wherein in response to the current travelling state of the vehicle not matching the vehicle default state, outputting the driving alarm signal and/or the control signal for instructing the vehicle to switch from the current state to the vehicle default state comprises:
in response to the current travelling state of the vehicle not matching the vehicle default state corresponding to the lane line departure detection result, or in response to the current travelling state of the vehicle not matching the vehicle default state corresponding to the lane line departure detection result and a change trend of the lane line departure detection result indicating that a degree of lane line departure remains or increases, issuing a prompt information to turn on a turn lamp and/or controlling the vehicle to turn on the corresponding turn lamp according to the default travelling state corresponding to the lane line departure detection result.

10. The method according to claim 9, wherein issuing the prompt information to turn on the turn lamp and/or controlling the vehicle to turn on the corresponding turn lamp according to the default travelling state corresponding to the lane line departure detection result comprises:
determining to issue the prompt information to turn on the turn lamp and/or control the vehicle to turn on the corresponding turn lamp in conjunction with the traffic sign detection result and/or the traffic light state detection result.

11. The method according to claim 8, wherein in response to the current travelling state of the vehicle not matching the vehicle default state, outputting the driving alarm signal and/or the control signal for instructing the vehicle to switch from the current state to the vehicle default state comprises:
in response to the current travelling state of the vehicle not matching the vehicle default state corresponding to the lane line departure detection result, acquiring a fluctuation range of a distance between the vehicle and the lane line; and
in response to the fluctuation range exceeding a safe distance range within a duration of a set threshold for an alarm time, outputting the driving alarm signal and/or controlling the vehicle to keep the distance between the vehicle and the lane line within the safe distance range.

12. The method according to claim 8, wherein the default travelling state corresponding to the detection result is determined based on the relative position information and a type of the lane line, the type of the lane line comprising at least one of a broken white line, a solid white line, a broken yellow line, a solid yellow line, double broken white lines, double solid yellow lines, a solid yellow line with broken yellow line, and double solid white lines.

13. The method according to claim 12, wherein the lane line comprises at least one of traffic markings on both sides of the lane, stop line, and turning guide line.

14. The method according to claim 4, wherein when a target object is a traffic light, detecting the traffic signal of the vehicle travelling environment to obtain the detection result of the traffic signal comprises:
acquiring a video stream including the traffic light by an image collection device provided on the vehicle; and
performing a traffic light state detection on at least one frame image in the video stream to determine the traffic light state detection result.

15. The method according to claim 14, wherein in response to the current travelling state of the vehicle not matching the vehicle default state, outputting the driving alarm signal and/or the control signal for instructing the vehicle to switch from the current state to the vehicle default state comprises:
in response to the current travelling state of the vehicle not matching the default travelling state corresponding to the traffic light state detection result, outputting the driving alarm signal, and/or outputting the driving alarm signal, and/or outputting an instruction for controlling the vehicle to turn on a turn lamp, decelerate, brake and/or steer.

16. The method according to claim 4, wherein when a target object is a traffic police instruction, detecting the traffic signal of the vehicle travelling environment to obtain the detection result of the traffic signal comprises:
collecting a video stream including a traffic police by an image collection device provided on the vehicle; and
performing a traffic police instruction detection on at least one frame image in the video stream to obtain the traffic police instruction detection result.

17. The method according to claim 16, wherein in response to the current travelling state of the vehicle not matching the vehicle default state, outputting the driving alarm signal and/or the control signal for instructing the vehicle to switch from the current state to the vehicle default state comprises:
in response to the current travelling state of the vehicle not matching the vehicle default state corresponding to the traffic police instruction detection result, outputting the driving alarm signal and/or an instruction control signal which is based on the default travelling state corresponding to the traffic police instruction detection result, wherein the instruction control signal includes at least one of prompt information for turning on a turn lamp, controlling the vehicle to turn on a corresponding turn lamp, controlling the vehicle to steer, controlling the vehicle to brake, and controlling the vehicle to stop.

18. An intelligent driving control device, comprising:
a processor; and
a memory configured to store executable instructions,
wherein the processor is configured to execute the instructions stored in the memory, so as to:
detect a traffic signal of a vehicle travelling environment to obtain a detection result of the traffic signal;
acquire a current travelling state of a vehicle and a vehicle default state corresponding to the detection result of the traffic signal;
determine whether the current travelling state of the vehicle matches the vehicle default state; and
output a driving alarm signal and/or a control signal for instructing the vehicle to switch from a current state to the vehicle default state in response to the current travelling state of the vehicle not matching the vehicle default state.

19. The device according to claim 18, wherein outputting the driving alarm signal and/or the control signal for instructing the vehicle to switch from a the current state to the vehicle default state in response to the current travelling state of the vehicle not matching the vehicle default state comprises:
in response to the current travelling state of the vehicle not matching the vehicle default state corresponding to the lane line departure detection result, acquiring a fluctuation range of a distance between the vehicle and the lane line; and
in response to the fluctuation range exceeding a safe distance range within a duration of a set threshold for an alarm time, outputting the driving alarm signal and/or control the vehicle to keep the distance between the vehicle and the lane line within the safe distance range.

20. A non-transitory computer storage medium having computer-readable instructions stored thereon, wherein when being executed, the instructions perform the following operations:
detecting a traffic signal of a vehicle travelling environment to obtain a detection result of the traffic signal;
acquiring a current travelling state of a vehicle and a vehicle default state corresponding to the detection result of the traffic signal;
determining whether the current travelling state of the vehicle matches the vehicle default state; and
in response to the current travelling state of the vehicle not matching the vehicle default state, outputting a driving alarm signal and/or a control signal for instructing the vehicle to switch from a current state to the vehicle default state.
